(19) United States
(12) Patent Application Publication
(10) Pub. No.: US 2009/0177389 A1
(43) Pub. Date: Jul. 9, 2009

(54) TOUCH-CONTROLLED NAVIGATION DEVICE AND METHOD

(75) Inventor: Chiao-Fu WU, Taipei City (TW)

Correspondence Address: EGBERT LAW OFFICES, 412 MAIN STREET, 7TH FLOOR, HOUSTON, TX, 77002, US

(73) Assignee: MITAC INTERNATIONAL Corp., Kuei San Hsiang (TW)

(21) Appl. No.: 12/345,062

(22) Filed: Dec. 29, 2008

(30) Foreign Application Priority Data
Jan. 9, 2008 (TW) 097100882

(51) Int. Cl. G01C 21/36

(52) U.S. Cl. 701/209; 701/200

(57) ABSTRACT

A touch-control navigation device and method is characterized in that when an operation interface of the navigation device is touched to select an obstacle location on a certain section of a road, a plurality of menus is shown on the operation interface. Each of the menus corresponds to at least one obstacle item. A user may configure the setting of the obstacle items according to actual need, so that a navigation module of the device plans out a route based on a beginning position, a destination, information about a plurality of maps, information about a plurality of roads, and the setting configured for every obstacle item. In this manner, it is able to avoid the problem of planning out a non-passable route. A touch-control navigation method implemented based on the touch-control navigation device is also disclosed.

### CROSS-REFERENCE TO RELATED U.S. APPLICATIONS

Not applicable.

### STATEMENT REGARDING FEDERALLY SPONSORED RESEARCH OR DEVELOPMENT

Not applicable.

### NAMES OF PARTIES TO A JOINT RESEARCH AGREEMENT

Not applicable.

### REFERENCE TO AN APPENDIX SUBMITTED ON COMPACT DISC

Not applicable.

### BACKGROUND OF THE INVENTION

1. Field of the Invention

The present invention relates to a touch-control navigation device and method, and more particularly to a touch-control navigation device and method that allows user settings of obstacle items to help in planning out a passable route.

2. Description of Related Art Including Information Disclosed Under CFR 1.97 and 37 CFR 1.98.

Currently, a navigation system has gradually become standard equipment for a car. Alternatively, a handheld navigator may be disposed in a car to help a driver in navigating the car and planning out a route to avoid the confusion of getting lost. However, when a user sets a beginning position and a destination for the navigator to plan out a route, it is possible that some parts of the planned route are non-passable. This might occur because the maps stored in the electronic map database of the navigator or navigation system are too old to be consistent with the current road conditions or to comprise some temporary road construction conditions. There are navigation systems being provided with the function of re-planning a new route. However, so long as the electronic map database does not include the settings of the obstacles that result in non-passable roads, the re-planned route would still include some non-passable portions. Therefore, it is desirable to develop a navigation system that allows a user to configure the settings of the road obstacles on the navigation system in real time, so as to avoid the problem of planning out a non-passable route.

It is therefore tried by the inventor to develop a touch-control navigation device and method to overcome the above-mentioned problems in the prior art.

### BRIEF SUMMARY OF THE INVENTION

It is a primary object of the present invention to provide a touch-control navigation device and method to solve the problem of planning out a non-passable route by a prior art navigation device.

To achieve the above and other objects, the touch-control navigation device according to the present invention comprises an operation interface, a memory, and a navigation module. The operation interface comprises a plurality of menus, each of which corresponds to at least one obstacle item. The memory has an electronic map database and a predetermined route planning program stored thereon. The electronic map database stores map information therein, which comprises road messages for a plurality of roads. The predetermined route planning program allows a user to configure the setting of an obstacle item according to actual need. The navigation module plans a route based on a beginning position, a destination, the map information, the road messages, and the user configures the setting of every obstacle item.

The touch-control navigation method according to the present invention comprises the following steps: turning on a touch-control navigation device to display an electronic map on an operation interface of the touch-control navigation; touching the electronic map to select an obstacle location with an input device; showing a plurality of menus on the operation interface in response to the selection of the obstacle location, and each of the menus corresponding to at least one obstacle item; selecting one of the menus to configure the setting of one corresponding obstacle item; verifying whether the setting of the selected obstacle item has been successfully configured; if the setting of the selected obstacle item is successfully configured, storing the obstacle item on a memory of the touch-control navigation device; and if the setting of the selected obstacle item is not correctly configured, re-selecting one of the menus to configure the setting of one corresponding obstacle item thereof; and planning out a route according to the obstacle item.

In the event an obstacle location is wrongly selected on the operation interface, the user may return to a window that shows the plurality of menus, so as to touch and select another correct obstacle location and configure the setting of an appropriate obstacle item to thereby correct the previously selected obstacle location and edit the setting of the obstacle item again. Moreover, the selection of obstacle locations and the editing of setting of obstacle items may be done in advance according to actual need so as to simplify the route planning and save the time and operating procedures needed to re-plan the route. Therefore, it is able to avoid the problem of planning out a non-passable route in the route re-planning, and the navigation device will be more practical and convenient for use.

### BRIEF DESCRIPTION OF THE SEVERAL VIEWS OF THE DRAWINGS

The structure and the technical means adopted by the present invention to achieve the above and other objects can be best understood by referring to the following detailed description of the preferred embodiments and the accompanying drawings.

FIG. 1 is a block diagram of a touch-control navigation device according to the present invention.

FIGS. 2A, 2B and 2C show schematic views of an example of using the touch-control navigation device of the present invention.

FIG. 3 is a flowchart showing the steps included in a touch-control navigation method according to the present invention.

### DETAILED DESCRIPTION OF THE INVENTION

The present invention will now be described with a preferred embodiment thereof. For the purpose of easy to understand, like elements in the preferred embodiment are denoted by the same reference numerals.

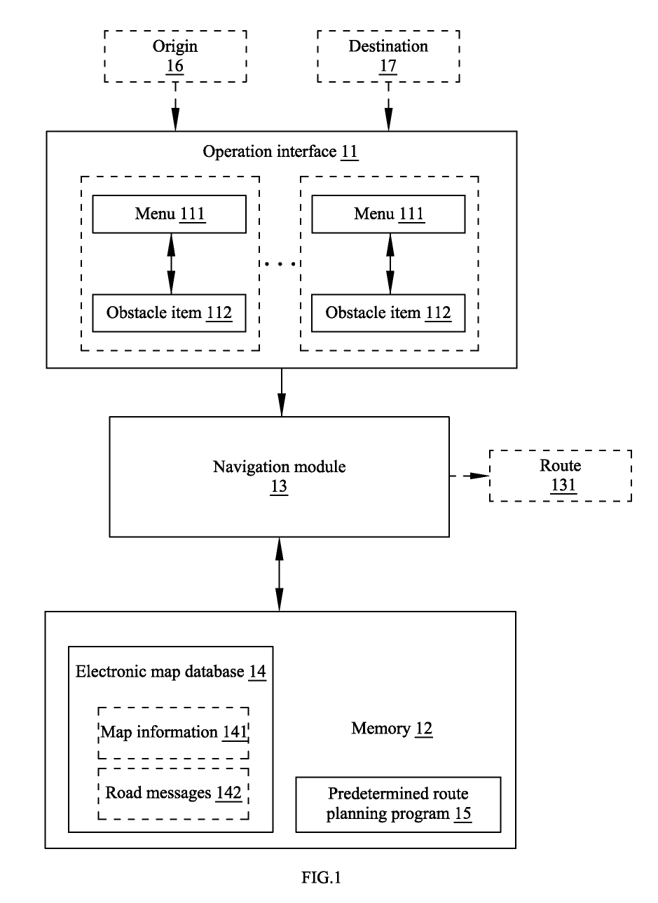

Referring to FIG. 1, there is a block diagram of a touch-control navigation device according to the present invention. As shown, the touch-control navigation device comprises an operation interface 11, a memory 12, and a navigation module 13. The operation interface 11 has a plurality of menus 111. Each of the menus 111 corresponds to at least one obstacle item 112. In the memory 12, there are stored an electronic map database 14 and a predetermined route planning program 15. The electronic map database 14 has map information 141 stored therein, and the map information 141 comprises road messages 142 in connection with a plurality of roads. The predetermined route planning program 15 allows a user to configure the setting of an obstacle item 112 according to actual need. When the navigation module 13 receives data transmitted from a satellite and calculates the data to derive a current position of the user's car in moving, the predetermined route planning program 15 stored in the memory 12 will be run to plan out a passable route 131 based on a beginning position 16 and a destination 17 input by the user, the map information 141, the road messages 142, and the user configures the setting of every obstacle item 112. And, the navigation module 13 may display a navigation message on the operation interface 11, such as a video message showing a length of road between the beginning position 16 and the destination 17 to be passed. Alternatively, the navigation module 13 may provide a voice message, such as “Turn left at the next cross road”, “Speed limit 40 km, drive carefully” or the like, so as to help the user to reach the destination. The navigation mode as illustrated above, e.g., the vehicle navigation mode, is only an exemplary navigation mode. The present invention may be applicable to various navigation modes, such as the pedestrian mode.

The touch-control navigation device may be an in-car computer, a portable electronic device, a personal digital assistant (PDA), or a smart mobile phone. The navigation module 13 is preferably a global positioning system (GPS) module. The operation interface 11 is preferably a touch panel.

A user may edit or change the settings of the obstacle items 112 on the operation interface 11 via an input device, which may be a fingertip or a stylus. The menus 111 comprise at least one permanent obstacle menu, a temporary obstacle menu, and a cancel obstacle menu. The permanent obstacle menu corresponds to a permanent obstacle item, and the permanent obstacle menu further comprises at least one obstacle list message, an OK button, and a Return button. With the permanent obstacle menu, a user may set the navigation device to plan out a route to avoid an obstacle location. The temporary obstacle menu corresponds to a temporary obstacle item, and the temporary obstacle menu further comprises at least an obstacle list message, a time duration setting, an OK button, and a Return button. With the temporary obstacle menu, a user may set the navigation device to plan out a route to temporarily avoid an obstacle location. The time duration setting allows the user to set according to actual need a predetermined period of time within which an obstacle location is maintained as valid, so that the obstacle location is maintained valid within the preset time duration or is automatically canceled when the preset time duration is lapsed. In the latter case, the previous setting of planning out a route to temporarily or permanently avoid the obstacle location is also canceled. The cancel obstacle menu corresponds to a cancel obstacle item, which further comprises at least an OK button and a Return button, and is used to cancel an obstacle location.

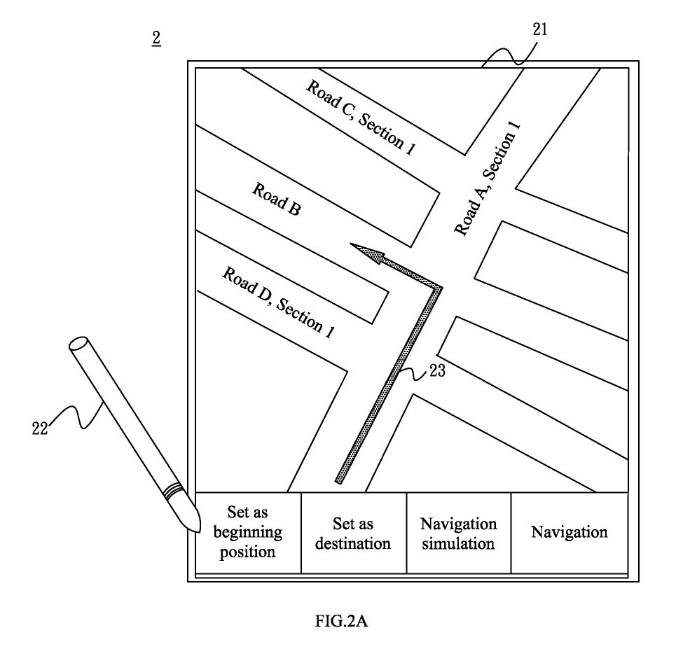

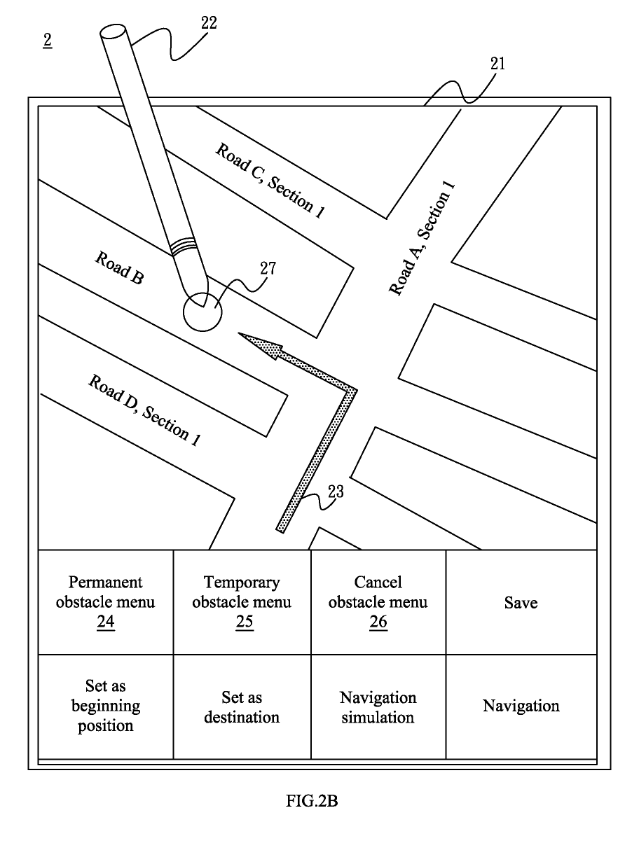

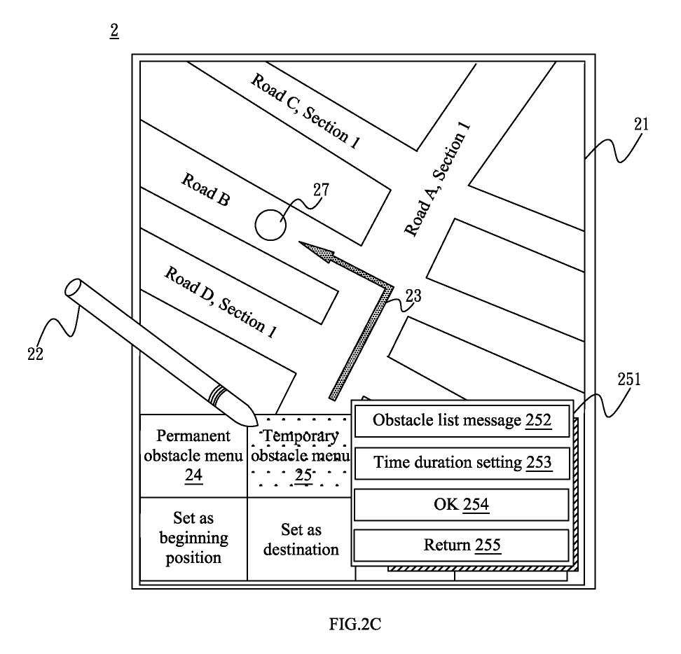

Referring to FIGS. 2A, 2B, and 2C, the figures show an example of using the touch-control navigation device of the present invention. In FIG. 2A, the touch-control navigation device is a PDA 2 with a navigation function. When the PDA 2 is turned on to display an electronic map on a touch panel 21 of the PDA 2, a user may touch the touch panel 21 with a fingertip or a stylus 22 to set a beginning position 16 and a destination 17 on the electronic map. At this point, a navigation module of the PDA 2 would follow the beginning position 16, the destination 17, and the map information 141 and the plurality of road messages 142 stored on the memory 12 (not shown in FIG. 2A) to plan out a route 23 and display a navigation video message on the touch panel 21 or output a navigation voice message to help the user in arriving a destination successfully.

FIG. 2B shows an example of using the obstacle menu according to a navigation method of the present invention. As shown, the user follows the route 23 to drive along the Road A, Section 1 and is informed by a navigation message to turn left to the Road B. However, when the user turns left, it is found the Road B is closed due to road construction. At this point, the user may touch the touch panel 21 at the construction location on the Road B with a fingertip or the stylus 22 to set the construction location as an obstacle location 27. Then, the touch panel 21 will display a permanent obstacle menu 24, a temporary obstacle menu 25, and a cancel obstacle menu 26. These menus 24, 25, 26 correspond to a permanent obstacle item, a temporary obstacle item 251, and a cancel obstacle item, respectively.

In FIG. 2C, the user may touch to select the temporary obstacle menu 25 to display the corresponding temporary obstacle item 251. The temporary obstacle item 251 further corresponds to some function items, comprising at least one obstacle list message 252, a time duration setting 253, an OK button, and a Return button 255. The time duration setting 253 allows the user to set according to actual need a period of time within which the obstacle location 27 is maintained as valid. For example, the time duration for the obstacle location 27 may be 2 days. In this case, when the navigation module of the PDA 2 runs the route planning program, it will plan out a route 23 to avoid the obstacle location 27 within the time duration of two days. The obstacle list message 252 shows all obstacle locations 27 that have been set as temporary obstacle locations.

After completing the configuration of the setting of the temporary obstacle item 251, the user may touch the OK button 254 to save the temporary obstacle item 251 on a memory 12 (not shown in FIGS. 2A, 2B, and 2C) of the PDA 2. And, the navigation module of the PDA 2 will plan out another new passable route according to the temporary obstacle item 251. In the event that the setting of the temporary obstacle item 251 is wrongly configured, the user may touch the Return button 255 to go back to a window that shows the menus 24, 25, and 26, so as to touch and select another correct obstacle location or to touch and select another desired menu from the three menus 24, 25, and 26. Further, when the time duration set for the obstacle location 27 lapses, the navigation module will automatically cancel the obstacle location 27 and other setting related to the temporary obstacle item 251, so as to plan out a route passing through the Road B.

In the event that a certain road within the planned route has already been planned as a community or a building construction site and becomes a permanently no-pass road, the user may touch the touch panel 21 at the permanently no-pass road to set it as an obstacle location 27, and touch and select the permanent obstacle menu 24 to show the corresponding permanent obstacle item thereof. The permanent obstacle menu further comprises at least an obstacle list message, an OK button, and a Return button. The permanent obstacle item may correspond to the obstacle list message, the OK button or the Return button. With the permanent obstacle item, the navigation device may plan out a route to permanently avoid the permanent obstacle location 27. Since the procedures for executing the permanent obstacle menu 24 are the same as those for executing the temporary obstacle menu 25, they are not repeated herein.

When the obstacle location 27 has been set and the permanent obstacle item or the temporary obstacle item 251 has been saved on the memory 12, and it is desired to cancel the previously set obstacle location 27 from the obstacle list message, the user may touch and select the cancel obstacle menu 26 to show the corresponding permanent obstacle item or temporary obstacle item 251. The cancel obstacle menu further comprises at least an Ok button and a Return button. With the cancel obstacle item, the user may cancel the obstacle location 27 from the electronic map displayed on the touch panel 21, so that the settings of the permanent obstacle item or the temporary obstacle item 251 may be edited and updated, making the navigation device more practical for use.

The obstacle locations 27 set in different menus may be indicated by different marks or different symbols. For example, a permanent obstacle location may be set and indicated by a red mark or a diamond symbol; and a temporary obstacle location may be set and indicated by a blue mark or a square symbol.

Moreover, the user may touch the electronic map information at two or more locations along a road shown on the electronic map to set two or more obstacle locations 27. A road section between two obstacle locations 27 may be set as an obstacle road range, and the navigation module of the PDA 2 may plan out a route 23 to temporarily or permanently avoid the obstacle road range.

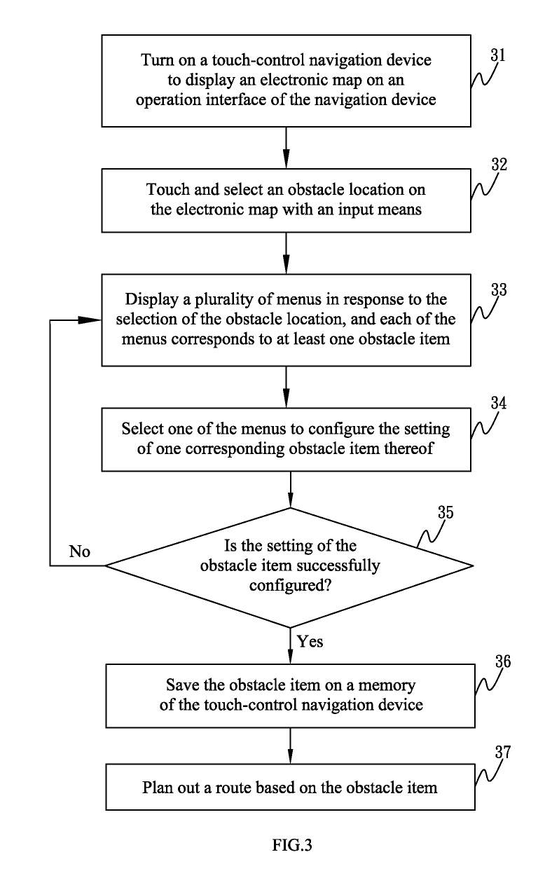

FIG. 3 is a flowchart showing the steps included in a touch-control navigation method according to the present invention. The steps for implementing the touch-control navigation method comprise:

Step 31: Turn on a touch-control navigation device to show an electronic map on an operation interface of the touch-control navigation device;

Step 32: Touch the electronic map to select an obstacle location with an input device;

Step 33: A plurality of menus is shown on the operation interface in response to the selection of the obstacle location, and each of the menus corresponds to at least one obstacle item;

Step 34: Select one of the menus to configure the setting of one corresponding obstacle item thereof;

Step 35: Verify whether the setting of the selected obstacle item has been successfully configured or not; if yes, execute the Step 36, and if no, repeat the Step 33;

Step 36: Save the obstacle item on a memory of the touch-control navigation device, so that the touch-control navigation device may plan out a route to avoid the obstacle location when a user drives along the same road next time; and

Step 37: Plan out a route according to the obstacle item.

The present invention has been described with a preferred embodiment thereof and it is understood that many changes and modifications in the described embodiment may be carried out without departing from the scope and the spirit of the invention that is covered by the appended claims.

1. A touch-control navigation device, comprising:
an operation interface comprising a plurality of menus, each of the menus corresponding to at least one obstacle item;
a memory comprising an electronic map database and a predetermined route planning program stored thereon, said electronic map database comprising plural pieces of map information,
wherein each plural piece of the map information comprises road messages of a plurality of roads, said predetermined route planning program allowing a configuration of a setting of the obstacle items stored therein; and
a navigation module means for planning a route based on a beginning position, a destination, the map information, the road messages, and the user configured setting of each of the at least one obstacle item.

2. The touch-control navigation device as claimed in claim 1, wherein the navigation module means comprises a global positioning system (GPS) module.

3. The touch-control navigation device as claimed in claim 1, wherein the operation interface is a touch panel.

4. The touch-control navigation device as claimed in claim 1, wherein the operation interface allows the user to edit or change the setting of the obstacle items on the operation interface with an input device.

5. The touch-control navigation device as claimed in claim 4, wherein the input device is selected from the group consisting of a fingertip and a stylus.

6. The touch-control navigation device as claimed in claim 1, wherein the operation interface allows the user to select two or more locations on one of the plurality of roads for setting as obstacle locations, and a section of the road between two different obstacle locations is set as an obstacle road range; and the navigation module makes the route planning program temporarily or permanently avoid the obstacle road range while planning the route.

7. The touch-control navigation device as claimed in claim 6, wherein the menus comprise at least a permanent obstacle menu, a temporary obstacle menu, and a cancel obstacle menu.

8. The touch-control navigation device as claimed in claim 7, wherein the permanent obstacle menu corresponds to a permanent obstacle item, and wherein the permanent obstacle menu further comprises at least an obstacle list message, a time duration setting, an OK button, and a Return button; wherein the permanent obstacle menu is used for making the navigation module permanently avoid the obstacle locations while planning the route.

9. The touch-control navigation device as claimed in claim 7, wherein the temporary obstacle menu corresponds to a temporary obstacle item, and wherein the temporary obstacle menu further comprises at least an obstacle list message, a time duration setting, an OK button, and a Return button, and wherein the temporary obstacle menu is used for making the navigation module temporarily avoid the obstacle locations while planning the route, the time duration setting is used for controlling validities of the obstacle locations in a certain period of time, and the obstacle locations are maintained or automatically canceled according to the time duration setting.

10. The touch-control navigation device as claimed in claim 7, wherein the cancel obstacle menu corresponds to a cancel obstacle item, and the cancel obstacle menu further comprises at least an OK button and a Return button; wherein the cancel obstacle menu is used for canceling the obstacle locations.

11. A touch-control navigation method, comprising the following steps:
turning on a touch-control navigation device to display an electronic map on an operation interface of the touch-control navigation device;
touching the electronic map to select an obstacle location with an input device;
showing a plurality of menus on the operation interface in response to the selection of the obstacle location, each of the plurality of menus corresponding to at least one obstacle item;
selecting one of the plurality of menus to configure the at least one obstacle item;
verifying whether the at least one obstacle item is successfully configured;
storing the at least one obstacle item on a memory of the touch-control navigation device, if the at least one obstacle item is successfully configured, and planning a route according to the at least one obstacle item.

12. The touch-control navigation method as claimed in claim 11, wherein the obstacle location set in a different menu is indicated by a different mark or symbol.

13. The touch-control navigation method as claimed in claim 11, wherein the operation interface is a touch panel.

14. The touch-control navigation method as claimed in claim 11, wherein the input device is used to edit or change the setting of the obstacle item on the operation interface.

15. The touch-control navigation method as claimed in claim 11, wherein the input device is selected from the group consisting of a user's fingertip and a stylus.

16. The touch-control navigation method as claimed in claim 11, wherein the operation interface allows the user to select two or more locations on a road for setting as obstacle locations, and a section of the road between two different obstacle locations is set as an obstacle road range; and a navigation module makes a route planning program temporarily or permanently avoid the obstacle road range while planning the route.

17. The touch-control navigation method as claimed in claim 16, wherein the menus comprise at least a permanent obstacle menu, a temporary obstacle menu, and a cancel obstacle menu.

18. The touch-control navigation method as claimed in claim 17, wherein the permanent obstacle menu corresponds to a permanent obstacle item, and the permanent obstacle menu further comprises at least an obstacle list message, a time duration setting, an OK button, and a Return button; wherein the permanent obstacle menu is used for making the touch-control navigation device permanently avoid the obstacle locations while planning the route.

19. The touch-control navigation method as claimed in claim 17, wherein the temporary obstacle menu corresponds to a temporary obstacle item, and the temporary obstacle menu further comprises at least an obstacle list message, a time duration setting, an OK button, and a Return button; wherein the temporary obstacle menu is used for making the touch-control navigation device temporarily avoid the obstacle locations while planning the route, the time duration setting is used for controlling validities of the obstacle locations in a certain period of time, and the obstacle locations are maintained or automatically canceled according to the time duration setting.

20. The touch-control navigation method as claimed in claim 17, wherein the cancel obstacle menu corresponds to a cancel obstacle item, and the cancel obstacle menu further comprises at least an OK button and a Return button; wherein the cancel obstacle menu is used for canceling the obstacle locations displayed on the operation interface.
